(19) United States
(12) Patent Application Publication
(10) Pub. No.: US 2016/0362938 A1
(43) Pub. Date: Dec. 15, 2016

(54) INSTRUMENTED PERCUSSION HAMMER BIT

(71) Applicant: Smith International, Inc., Houston, TX (US)

(72) Inventors: Xiaoge Gan, Houston, TX (US); Daniel J. Towner, Spring, TX (US); Angelo L. Spedale, Cypress, TX (US); Robert H. Slaughter, JR., Spring, TX (US); Rohan V. Neelgund, Houston, TX (US); Vineet V. Nair, The Woodlands, TX (US)

(21) Appl. No.: 15/176,224

(22) Filed: Jun. 8, 2016

Related U.S. Application Data
(60) Provisional application No. 62/174,468, filed on Jun. 11, 2015.

(51) Int. Cl. E21B 10/36; E21B 10/38; G06F 17/50; E21B 47/024; E21B 47/01; E21B 47/06; E21B 47/10

(52) U.S. Cl. CPC E21B 10/36; E21B 47/06; E21B 47/065; E21B 10/38; E21B 47/10; E21B 47/024; E21B 47/011; G06F 17/5009

(57) ABSTRACT

A percussion drilling assembly includes a housing and a drill bit within a lower end of the housing. At least one of a piston or an anvil is within the housing above the drill bit. The drilling assembly also includes at least one sensor in at least one of the housing, the piston, or the anvil. A method of drilling includes drilling a formation with a percussion drilling assembly, the percussion drilling assembly having at least one sensor located in a component thereof. The at least one sensor may measure at least one property of the percussion drilling assembly while drilling. The measurements taken by the at least one sensor may be analyzed and a new percussion drilling assembly designed based on the analysis.

### CROSS-REFERENCE TO RELATED APPLICATIONS

This application claims the benefit of, and priority to, U.S. Patent Application Ser. No. 62/174,468, filed on Jun. 11, 2015, which application is expressly incorporated herein by this reference in its entirety.

### BACKGROUND

Percussion hammer bits are used in earth boring applications including the recovery of oil, gas, or minerals; mining; blast holes; water wells; and construction projects. In percussion hammer drilling operations, a drilling assembly mounted to the lower end of a drill string rotates and impacts the earth in a cyclic fashion to crush, break, and loosen formation material. The drilling assembly includes a piston assembly coupled to the percussion hammer drill bit. The piston generates the impact force and transfers the force to the hammer drill bit. The impacting and rotating hammer bit engages the earthen formation and forms a borehole along a predetermined path toward a target formation.

Modifications to percussion hammer bit designs may be conceptualized and modeled in computer simulations. Simulations often rely on estimates of downhole conditions to predict performance of a percussion hammer bit design. If a particular modified design yields improved performance, then those modifications may be adopted into future percussion hammers.

### SUMMARY

In some aspects, embodiments of the present disclosure include a drilling assembly having a housing with a percussion drill bit slidingly positioned in a lower end of the housing. A piston is also slidingly disposed within the housing longitudinally above the percussion drill bit. A feed tube housing is located within the housing longitudinally above the piston. The piston is located within the housing such that an upper chamber is above the piston and a lower chamber is below the piston. A feed tube is positioned within the feed tube housing, such that the feed tube is in fluid communication with at least one of the upper chamber or the lower chamber. The drilling assembly also includes at least one sensor in at least one of the housing, the piston, the feed tube housing, or the feed tube.

In other aspects, embodiments of the present disclosure include a percussion drilling assembly having an outer housing with a drill bit located in a lower end of the housing. At least one of a piston or an anvil is slidingly disposed within the housing longitudinally above the drill bit. The drilling assembly also includes at least one sensor in at least one of the housing, the piston, or the anvil.

In still other aspects, a method in accordance with embodiments disclosed herein includes drilling a formation with a percussion drilling assembly. The percussion drilling assembly has at least one sensor located in a component of the percussion drilling assembly. The at least one sensor may measure at least one property of the percussion drilling assembly. The measurements taken by the at least one sensor may be analyzed and a new percussion drilling assembly may be designed based on the analysis.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

FIG. 1 shows a cross-sectional view of a percussion hammer according to embodiments of the present disclosure.

FIGS. 2 and 3 show cross-sectional views of a drilling assembly in a first position according to embodiments of the present disclosure.

FIG. 4 shows a perspective view of a feed tube housing according to embodiments of the present disclosure.

FIGS. 5 and 6 show cross-sectional views of a feed tube housing according to embodiments of the present disclosure.

FIG. 7 shows a perspective view of a feed tube according to embodiments of the present disclosure.

FIG. 8 shows a perspective view of a piston according to embodiments of the present disclosure.

### DETAILED DESCRIPTION

Embodiments disclosed herein relate to percussion drill bit assemblies and methods of manufacturing percussion drill bit assemblies. In one aspect, embodiments disclosed herein relate to positioning instrumentation (e.g., sensors or loggers) in at least one component of a percussion drill bit assembly. Embodiments disclosed herein relate to hydraulically and pneumatically actuated percussion drill bit assemblies as well as magnetically actuated drill bit assemblies. The instrumentation may monitor at least one property of the percussion drill bit assembly during operation.

In another aspect, embodiments disclosed herein relate to methods of designing percussion drill bit assemblies. For example, instrumentation provided to the drill bit assembly may collect empirical data during operation. The empirical data collected by the instrumentation may be input into models for analysis to more accurately simulate the assembly during operation. In another aspect, new percussion drill bit assembly designs may be modified based on the analysis of the updated models.

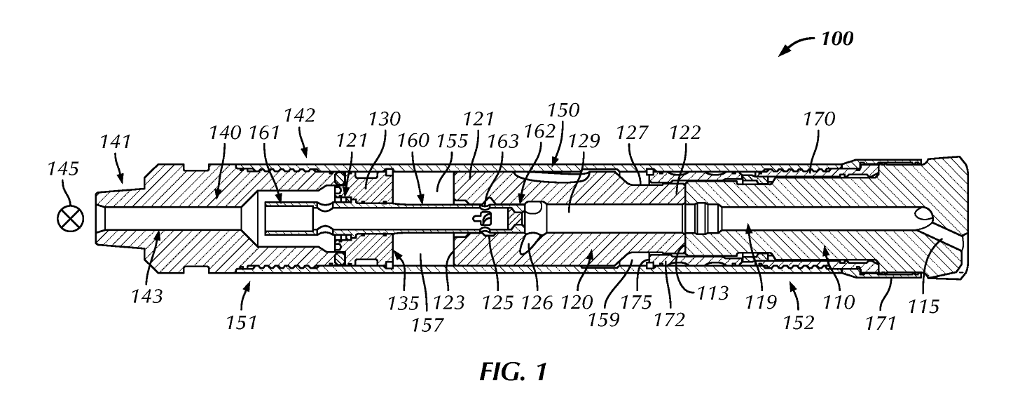

FIGS. 1-3 show examples of bottomhole assemblies. As used herein, the terms “percussion drill bit assembly” and “percussion drilling assembly” may be used interchangeably to refer to assemblies in accordance with embodiments of the present disclosure, for example, percussion drill bit assemblies 100 and 200. A percussion drill bit assembly may be hydraulically or pneumatically actuated, such as percussion drill bit assembly 100 or may be a magnetically actuated drill bit assembly, such as percussion drill bit assembly 200. Referring initially to FIG. 1, a percussion drill bit assembly 100 is shown. Assembly 100 may be connected to a lower end of a drill string to drill through subterranean geological formations. Assembly 100 may include a connection sub 140, a housing 150 located below the connection sub 140, a piston 120 slidingly positioned in a central chamber 155 of the housing 150, a sleeve 170 located within a lower end of the housing 150, a drill bit 110 slidingly received in the sleeve 170, and at least one sensor located in a component of the percussion drilling assembly 100 (e.g., 430 in FIG. 5). The sleeve and the drill bit may include splines, such that the splines of the sleeve 170 correspond to the splines located on the drill bit 110. As used herein, directional terms such as “above,” “proximal,” and “upper” refer to a relatively uphole position; directional terms such as “below,” “distal,” and “lower” refer to a relatively downhole position.

Housing 150 includes an upper end 151 and a lower end 152. A central chamber 155 of the housing 150 is formed between the upper end 151 and the lower end 152. Connection sub 140 also includes an upper end 141 and a lower end 142. The upper end 141 of connection sub 140 may be connected to a drill string. The lower end 142 of connection sub 140 may be connected to housing 150. For example, the lower end 142 of the connection sub 140 may be threadably coupled to the upper end 151 of the housing 150. The sleeve 170 may be coupled to the lower end 152 of the housing 150. For example, sleeve 170 may be threadably engaged with the lower end 152 of the housing 150 such that at least a portion of the sleeve 170 extends below the lower end 152 of the housing 150. In other embodiments, the sleeve 170 may engage an internal shoulder of the housing 150. A bit retainer 171 may be coupled to an outer surface of the sleeve 170 and around an outer surface of the drill bit 110. In other embodiments, the assembly 100 may not include bit retainer 171.

The connection sub 140 includes a passageway 143. The passageway 143 provides fluid communication between the drill string and the percussion drill bit assembly 100. The passageway 143 may be a central passageway, in other words, the longitudinal axis of the passageway 143 may be coaxial with the longitudinal axis of the percussion drill bit assembly 100. A check valve 145 may be positioned above the connection sub 140 to regulate the fluid flow between the drill string and the percussion drill bit assembly 100. The check valve 145 may be a one way valve that allows fluid to flow downhole, but not uphole. A feed tube 160 having a central bore therethrough is located in the housing 150 and is in fluid communication with the passageway 143. The feed tube 160 includes an upper end 161 and a lower end 162. As shown in FIG. 1, a portion of the upper end 161 of feed tube 160 may be positioned in a lower end 141 of the connection sub 140 proximate the passageway 143. The feed tube 160 may be a central feed tube, i.e., positioned coaxially with the longitudinal axis of the percussion drill bit assembly 100. In some embodiments, the check valve 145 may be positioned in the percussion drill bit assembly at the upper end 161 of feed tube 160.

A feed tube housing 130 may be positioned in the housing 150, below a lower end 142 of the connection sub 140. The feed tube housing 130 includes a central bore through which the feed tube 160 is inserted. The feed tube 160 may be coupled to the feed tube housing 130 by any means known in the art, for example, threaded connection, mechanical fasters, such as bolts, screws, etc., or a mechanical lock, as shown. As shown in FIG. 1, the feed tube 160 may include an increased diameter portion forming a shoulder or lip on an outer surface of the feed tube 160. The increased diameter portion is configured to contact a corresponding seat in the feed tube housing. One or more lock rings (e.g., threaded lock rings, threaded nut, etc.), seals, or the like may be secured around the feed tube 160 in the feed tube housing 130 to secure the feed tube 160 within the feed tube housing 130. Any or each of the one or more lock rings, the seals, or the feed tube housing 130 may be formed from a compliant material, e.g., an elastomer or spring system, to reduce stresses due to non-concentric vibrations. In some embodiments, the increased diameter portion of the feed tube 160 may be positioned between a first and second elastomeric ring to ensure feed tube 160 remains concentric to the inner diameter of the piston 121 by allowing slight movement of the feed tube 160 in the event of, for example, non-uniform wear or tolerance stack-ups. The feed tube housing 130 may include a seal assembly 121 to prevent fluid from bypassing the feed tube 160 and flowing downhole.

The feed tube 160 extends between a lower end 142 of the connection sub 140 to an upper end 121 of the piston 120. The lower end 162 of feed tube 160 may be in fluid communication with a passageway 129 of the piston 120 if there is excess fluid that the operator wishes to bypass the upper or lower chambers 157, 159. Otherwise, the bottom of the feed tube 160 includes an obstruction, e.g., a plug or valve, to ensure fluid does not bypass the central chamber 155. According to some embodiments, a portion of the lower end 162 of the feed tube 160 may be positioned in one or both of an upper end 121 of the piston 120 or a passageway 129 of piston 120 such that the piston slidingly receives the feed tube 160. The lower end 162 of the feed tube 160 may include one or more ports extending from the central bore of the feed tube 160 through a wall of the feed tube 160, i.e., from an inner surface to an outer surface. The piston 120 may include a plurality of ports 125, 126 extending from the passageway 129 to an outer surface of the piston 120. In some embodiments, at least one port 126 fluidly connects the central passageway 129 to the upper chamber 157, and at least one port 125 fluidly connects the ports 163 on the feed tube 160 to the lower chamber 159 when the piston 120 is in the lower position, as shown in FIG. 1.

One or more grooves (830 in FIG. 8) may be formed on an inner surface of the piston 120 or an outer surface of the feed tube 160 to facilitate fluid communication between the ports 125, 126 of the piston 120 and the ports 163 of the feed tube 160 when the ports 125, 126 are not aligned with ports 163, e.g., the piston 120 is rotationally shifted with respect to the feed tube 160. In addition, the piston 120 may have grooves (828 in FIG. 8) which connect ports 125 to the lower chamber 159, and grooves (829 in FIG. 8) which connect ports 126 to the upper chamber 157. During operation, the plurality of ports 125 and 126 of the piston 120 may alternately align and misalign with the plurality of ports 163 of the feed tube 160. When the piston 120 slides up so that ports 163 align with ports 126, the wall of the feed tube 160 will be positioned such that ports 126 are no longer in fluid communication with the central bore 129. At this position, the lower end of the piston 120 may be located axially above the guide sleeve 172, and fluid trapped in the lower chamber 159 is allowed to exhaust out through the bit bore 119.

The piston 120 is located in the central chamber 155 of the housing 150 such that the piston 120 is slidingly positioned between feed tube housing 130 and percussion bit 110. During operation, fluid is communicated from the surface, down through the drill string, through the passageway 143 in the connection sub 140, and through the feed tube 160 to the piston 120. As a result, the piston 120 may move up and down relative to the feed tube 160 and the rest of the drill bit assembly 100. The position of the piston 120 may divide the central chamber 155, such that there is an upper chamber 157 located above the piston 120, and a lower chamber 159 located between the piston 120 and the drill bit 110.

The upper chamber 157 describes a region of space above the piston, e.g., between an upper face 123 of the piston 120 and a lower face 135 of the feed tube housing 130. Piston ports 126 may be in fluid communication with the upper chamber 157. For example grooves (128 in FIG. 8) formed in at least one of the piston 120 or the outer surface of the feed tube housing may extend from the port 126 to the upper chamber 157. The upper chamber 157 may include the space occupied by the ports 126, for example, when the piston 120 is located in a proximal region of the chamber 155, feed tube 160 may obstruct the ports 126, such that ports 126 are no longer in fluid communication with passageway 129. The lower chamber may describe the region of space below the piston, e.g., between the piston 120 and the upper face 175 of a guide sleeve 172. When the piston 120 is in the lower position as shown in FIG. 1, Piston ports 125 may be in fluid communication with the lower chamber 159. For example grooves (828 in FIG. 8) formed in at least one of the outer surface of the piston 120 or the inner surface of the housing 150 may extend from the port 125 to the lower chamber 159.

During operation, as the piston 120 moves within central chamber 155, the sizes of the upper chamber 157 and the lower chamber 159 change accordingly. Referring to FIG. 1, the piston 120 is located at the distal end of central chamber 155, or a lower position. As a result, the upper chamber 157 is at a maximum size and the lower chamber 159 is at a minimum size. At this position, the piston strikes the upper face (or strike face) 113 of the drill bit 110. Fluid exits the feed tube 160 through the feed tube ports 163 and travels through the piston ports 125 into the lower chamber 159, thereby allowing pressure to build in the lower chamber 159. Meanwhile, fluid in the upper chamber 157 may vent by entering a distal portion of the central bore 129, allowing upper chamber pressure to decrease. The pressure differential between the upper chamber 157 and the lower chamber 159 causes the piston 120 to move uphole and the size of the upper chamber 157 will decrease as the size of the lower chamber 159 increases until the piston 120 reaches an upper position.

When the piston 120 is located in the upper portion of chamber 155, fluid supplied from the feed tube 160 and through the feed tube ports 163, flows through the ports 126. With the piston 120 in the upper position, the ports 126 are not in fluid communication with passageway 129, and as such, fluid is not permitted to vent into the passageway 129. This allows pressure to increase in the upper chamber 157. Additionally, when the piston 120 is in the upper portion of chamber 155, ports 125 are blocked by a wall of the feed tube 160 preventing further fluid flow to the lower chamber 159. Fluid present in the lower chamber may vent to the bit bore 119, thereby decreasing the pressure in the lower chamber 159. The pressure differential between the upper chamber 157 and the lower chamber 159 causes the piston 120 to move downward and return to the striking position. The piston 120 cycles between an upper position and a lower position during operation, striking the drill bit 110 at the lower position.

Fluid pumped downhole during operation, e.g. drilling fluid or air, may exit percussion drill bit assembly 100 through the drill bit 110 for cuttings removal, drill bit cleaning, bottom hole cleaning, drill bit cooling. The fluid may exit the drill bit 110 through, for example, passageway 115. According to some embodiments, passageway 115 may include a nozzle.

As discussed herein, one or more sensors, e.g., a data logger, may be located in one or more components of a percussion drilling assembly, e.g., percussion drilling assembly 100, to measure one or more properties or downhole conditions of the percussion drilling assembly 100. According to embodiments of the present disclosure, at least one sensor is located in at least one of the housing 150, the feed tube housing 130, the feed tube 160, the piston 120, or the drill bit 110. As used hereafter, the term “components” may refer to any component of a percussion drilling assembly which may include, but is not limited to, the housing 150, the feed tube housing 130, the feed tube 160, the piston 120, guide sleeve 172, and the drill bit 110.

Placing the sensor allows measurements and empirical data regarding the components of the percussing drilling assembly and downhole conditions to be gathered during operation. For example, empirical data regarding properties of fluid chambers (i.e., pressure, temperature, etc. of central chamber 155 including upper chamber 157 and lower chamber 159), kinematics of one or both of the piston or the drill bit, stress and strain of components, and fluid properties may be determined. The type of measurements and empirical data gathered depends on the type of sensor used and the placement of the sensors in the various components. For example, an accelerometer may be used to measure the acceleration of a component. Based on the acceleration, one skilled in the art may empirically determine the acceleration, as well as other useful properties, such as the force, impulse, or kinetic energy imparted by a component, a velocity profile of the piston 120, a distance profile of the piston 120, and lateral or rotational movement of the piston 120 or the drill bit 110.

The types of sensors used may include, for example, pressure sensors or loggers, temperature sensors or loggers, flow sensors, optical sensors, touch sensors, e.g., limit switches or resistance switches, position sensors, proximity sensors, strain gauges, accelerometers, magnetic sensors, etc. The sensors may be operatively coupled to a control center located in the drill string. The control center may include a board with a microprocessor in communication with equipment, e.g., computers, at the surface. The control center may communicate with the surface using, for example, telemetry, wireline, wireless communications, INTELLIPIPE®, and other communication methods known in the art. In some embodiments, the control center may communicate with other components of the drill string, e.g., check valve 145. In some embodiments, the sensors may be recovered manually after drilling to obtain the measurements. The sensors may be programmed to take measurements at pre-determined time intervals or the control center may send a signal to the sensors to take a measurement.

At least one sensor may be positioned in at least one component of a percussion drill bit assembly, e.g., percussion drill bit assembly 100. According to some embodiments, at least two sensors may be positioned a percussion drill bit assembly, e.g., at least one sensor may be placed in two different components, or at least two sensors may be placed in one component. The at least two sensors may be the same type of sensor or a different type of sensor. For example, two accelerometers may be located in the piston 120, a temperature sensor and a pressure sensor may be located in the feed tube housing 130, the same or other sensors may be used in additional or other locations, or combinations of the foregoing may be used. In embodiments where drill bit assembly 100 components include at least two sensors, the at least two sensors may be the same type of sensor or a different type of sensor, for example, the at least two sensors may be two temperature sensors or a temperature sensor and a pressure sensor. However, any suitable sensor may be used.

Each sensor may be located in a cavity formed in the corresponding component, for example, referring briefly to the feed tube housing 130 shown in FIG. 5, pressure logger 430 is located in cavity 460. As illustrated in FIG. 5, the pressure logger 430 may be oriented substantially perpendicular to a longitudinal axis of the drilling assembly. However, any suitable orientation and sensor may be used. According to some embodiments, more than one sensor may be located in a cavity. The cavity may be, for example, a bore or recess formed to receive a corresponding sensor or logger. A cap 420 may be located in the cavity to prevent fluid from entering the cavity. The cap 420 may prevent damage to the sensors or loggers and ensure that the sensors or loggers remain in place. Cap 420 may provide an obstruction to prevent large quantities of fluid from contacting the sensor 430. Insulation materials, e.g., aerogel, mineral wool, ceramic insulation, may be provided to each cavity to insulate the sensors or loggers from variant temperatures present in the drill bit assembly 100 and to eliminate or reduce oscillation of the sensors or loggers in the cavity during operation.

A sensor may be provided in a component to measure one or more properties of that component (e.g., temperature, stress, or strain of feed tube housing 130) or one or more properties of fluid proximate the component (e.g., pressure, viscosity, flow rate, or temperature of fluid in the upper chamber 155). For example, a strain gauge may be located in a component (e.g., at least one of the piston 120, feed tube housing 130, housing 150, guide sleeve 172, sleeve 170, or feed tube 160) to directly measure the strain, the stress, or both the strain and stress experienced by the component.

According to other embodiments, the strain or stress of a component may be indirectly determined based on measurements from sensors located therein. For example, referring briefly to FIGS. 5 and 6, the measurements taken by pressure logger 430 and temperature logger 450 of the feed tube housing 130 may be used to determine strain or stress due to pressure of the chamber and thermal expansion of the material, respectively. One skilled in the art will readily understand that temperature and pressure gauges located in other components (e.g., the piston 120, housing 150, or feed tube 160) may be used to determine strain or stress of the respective component. Further, any suitable sensor may be used to determine the strain or stress of a component. For example, the strain or stress of a component of the percussion drill bit assembly 100 may be determined with, for example, strain gauges, temperature, or pressure gauges.

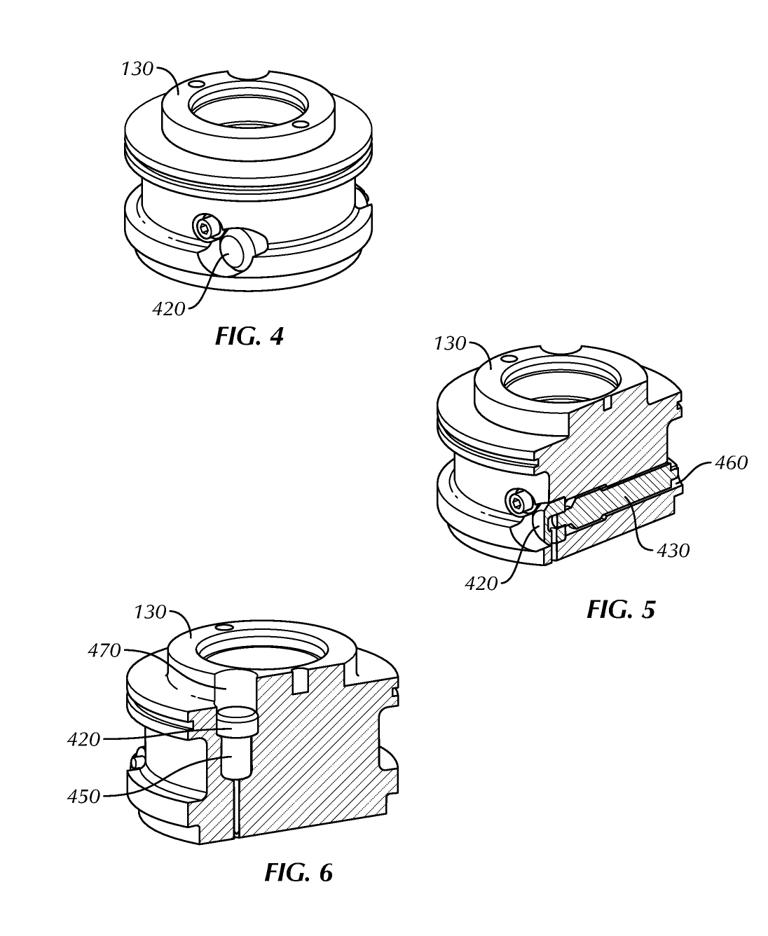

In another example, the feed tube housing 130 may include one sensor. According to some embodiments, the feed tube housing 130 may include at least two sensors or loggers. Referring to FIGS. 4-6 a feed tube housing 130 according to embodiments of the present disclosure is shown. The feed tube housing 130 includes a pressure logger 430 (FIG. 5) and a temperature logger 450 (FIG. 6). The sensors may be located in various locations within the components and access to the sensors may be provided by the cavities extending to an end or side face of the component. The pressure logger 430 and temperature logger 450 may measure the pressure and temperature, respectively, of the upper chamber 157 during operation. For example, a small hole may be drilled in the cap 420 so that one or more of the temperature or pressure of the fluid may propagate through the hole to the sensor or logger. The pressure logger 430 and temperature logger 450 are each located in cavities 460 and 470, respectively, formed in the feed tube housing 130. A cap 420 is located in each cavity to secure and keep sensors or loggers, e.g., pressure logger 430 and temperature logger 450, in place. The cavities may be oriented substantially parallel to an axis of the drilling assembly 100 (e.g., cavity 460 for pressure logger 430) or substantially perpendicular to an axis of the drilling assembly 100 (i.e., cavity 470 for temperature logger 450). However, one skilled in the art would understand that the orientation of a sensor, e.g., pressure logger 430 and temperature logger 450, and the corresponding cavity may vary based on, for example, the size and construction of a particular component, the orientation of the sensor with respect to the property, component, or fluid being measured, etc.

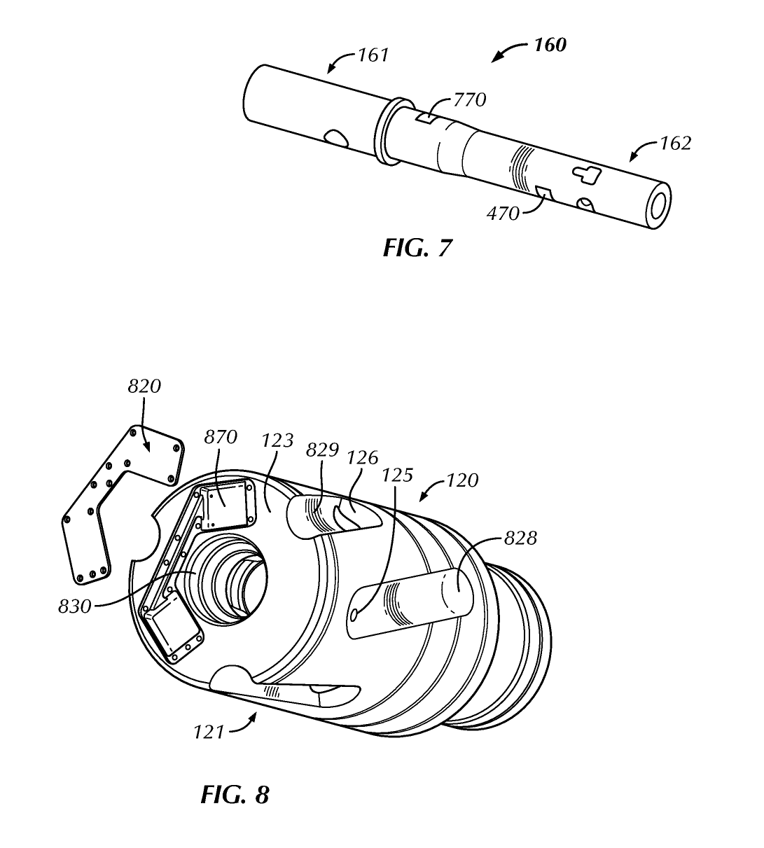

Referring to FIG. 7, in some embodiments, the feed tube 160 may have sensors located therein. The sensors may measure a property of the fluid, e.g., pressure or temperature, located in the feed tube 160, the upper chamber 157, lower chamber 159, or passageway 129. The sensors may measure a property of the feed tube 160, e.g., an accelerometer to measure vibration kinematics, a strain gauge to measure strain due to vibrations, or temperature sensors to determine the temperature of the feed tube 160 or possible temperature gradients.

One or more sensors may be positioned in at least one cavity 770. However, one skilled in the art will understand that more than one cavity 770 may be formed in the feed tube 160, and each cavity may house one or more sensors. The cavity 770 may extend, for example, from an outer wall of the feed tube 160 to an inner wall or a pocket formed on an outer wall that does not extend through to the inner wall. By positioning more than one sensor in the feed tube 160, the empirical data collected may be used to form a gradient representative of a property of feed tube 160 or fluid located in the feed tube 160 along the length of the feed tube 160. For example, a temperature sensor may be located proximate an upper end 161 of the feed tube 160 and a second temperature sensor may be located proximate the lower end 162. Thus, the measurements recorded from the first and second temperature sensor may be used to determine a temperature gradient along a length of the feed tube 160. Additional temperature sensors may be positioned at different locations along the length of the feed tube 160 for more precise determinations of the temperature gradient of the fluid or feed tube 160 along the length of the feed tube 160. One of ordinary skill in the art will appreciate that other types of sensors may be similarly positioned to determine, for example, pressure gradients, or other properties of the fluid or percussion bit assembly component.

The housing 150 may include at least one sensor. The sensors may measure a property of a fluid located in the upper chamber 157 or lower chamber 159, or a property of the housing 150 itself. In addition, sensors may be placed in the housing 150 to measure properties (e.g., pressure, temperature, flow rate, viscosity, etc.) of the return flow (i.e., flow of fluid that exits nozzle 115 and carries cuttings to the surface) in the borehole annulus. The sensors may be positioned in at least one cavity. The cavity may be located along the length of the housing and extend, for example, from an outer wall of the housing 150 to an inner wall. One skilled in the art will understand that more than one cavity may be formed in the housing 150. The sensors positioned in housing 150 may be substantially similar to the configuration of sensors illustrated in FIG. 7 with respect to the feed tube housing 160. As described with respect to the feed tube housing 160, more than one sensor may be positioned in the housing 150 to form a gradient representative a property of the fluid, the housing 150, or both the fluid and the housing 150 along the length of the housing 150.

The piston 120 may include at least one sensor positioned therein. Referring to FIG. 8, the at least one sensor may be located in cavity 870 formed in the upper face 123 of piston 120. The at least one sensor may be provided to measure a property of the upper chamber 157, for example, the property of a fluid located in the upper chamber 157. The at least one sensor may be, for example, an accelerometer, a temperature sensor, or a pressure sensor. According to some embodiments, more than one sensor may be located in cavity 870 of piston 120. The cap 820 may be a rubber element, a plate coupled to an O-ring, and any cap used for sealing and securing instrumentation as known in the art.

By way of example, referring again to FIG. 8, an accelerometer may be located in cavity 470. The accelerometer may include an accelerometer sensor to measure acceleration in at least one direction, i.e., along an x-axis, y-axis, and z-axis. For example, an accelerometer measuring movement in the x-axis, y-axis, and z-axis may also be used. In some embodiments, at least two accelerometers each measuring one axis may be used without departing from the scope of the present disclosure. The axes of the accelerometer may be positioned to correspond with axes of the drill bit assembly. For example, the y-axis of the accelerometer may be parallel to the longitudinal axis of the drilling assembly. The orientation and the number of axes measured by the accelerometer are not intended to limit the scope of the present disclosure.

According to another embodiment, a sensor may be located proximate one or more of a lower end 122 of piston 120 or an upper end of drill bit 110. One skilled in the art may recognize that due to the frequent movement of the piston 120 and the drill bit 110, the sensors may be positioned to ensure the mass of the piston 120 and drill bit 110 is substantially balanced. Additionally, sensors may be placed in the guide sleeve 172 in order to measure the fluid properties of the lower chamber 159, the temperature and strain of the guide sleeve 172, and the like. Again, the use of multiple sensors may provide a gradient of a measured property, e.g., a fluid property or a structural property.

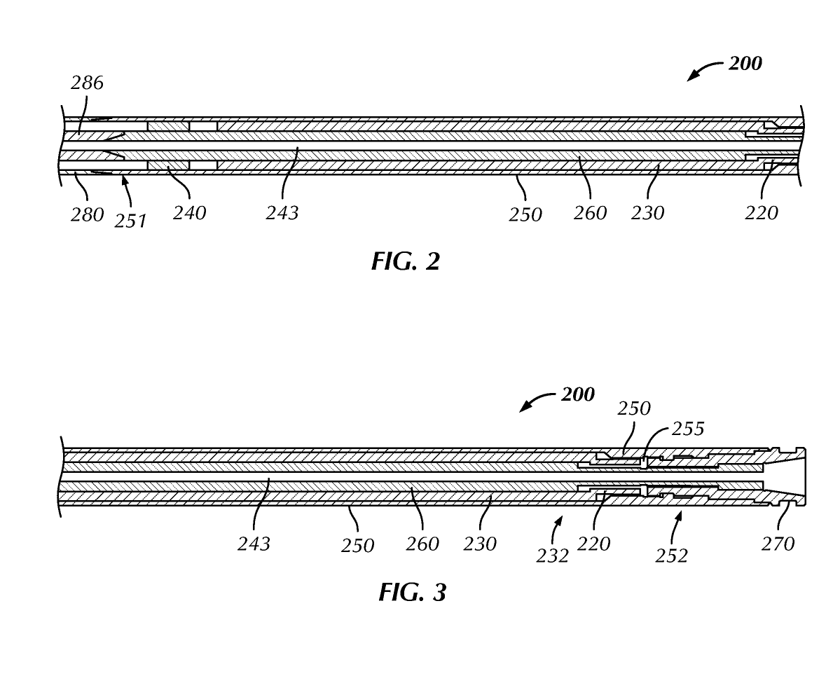

Embodiments of this disclosure also relate to instrumentation, i.e., sensors or loggers, provided to percussion drill bit assemblies that are magnetically actuated percussion drill bit assemblies. However, any suitable percussion drill bit assembly may be used. Referring to FIGS. 2 and 3, an example of a magnetically actuated percussion drill bit assembly 200 is shown. The drill bit assembly 200 may include a housing 250, a magnetic stator 230 located in the housing 250, a magnetic rotor 260 located in the magnetic stator 230, an anvil 220 slidingly located at a lower end of the magnetic stator 230, a bit box assembly 270 including a drill bit, and at least one sensor located in the percussion drill bit assembly 200.

An upper end 251 of the housing 250 is connected to a mud motor housing 280, the lower end 252 of the housing 250 is slidingly connected to the bit box 270. The housing 250 may be connected to the mud motor housing 280. The bit box 270 is slidingly connected to the housing 250 with, for example, splines, keys, a flats system, or radial bearings (e.g., journal bearings). The drill bit may be rotated with the housing 250 by, for example, rotation of the drill string or a downhole motor. For example, when the bit box 270 is coupled to the housing 250 with radial bearings, the motor that drives rotation of the magnetic rotor 260 may drive rotation of the bit box 270.

The magnetic stator 230 may be located coaxially inside the housing 250. The magnetic stator 230 may be splined to the housing 250 to prevent relative rotational movement. The splines allow the magnetic stator 230 to translate up and down relative to the housing 250. The magnetic stator 230 may travel a greater axial distance than the bit box 270. An anvil 220 may be located at a lower end 232 of the magnetic stator 230. In some embodiments, the anvil 220 may be coupled to the lower end 232 of the magnetic stator. In some embodiments, the anvil 220 may be formed integrally with the magnetic stator 230.

A magnetic rotor 260 may be located within the magnetic stator 230 and is configured to move rotationally with respect to the magnetic stator 230. Thrust bearings may be coupled to the rotor 260 to prevent axial movement of the rotor 260. An upper end of the magnetic rotor 260 may extend longitudinally above the magnetic stator 230, where the magnetic rotor 260 is connected to a mud motor 286. A lower end of the magnetic rotor 260 extends into the bit box 270. In some embodiments, the magnetic rotor 260 may be coupled to the bit box assembly 270 to rotate the bit box assembly 270 including the drill bit.

A seal assembly 240 may be provided in the annulus formed between the magnetic rotor 260 and the housing 250 above the magnetic stator 230. The seal assembly may fluidly isolate the stator from the mud motor. At a lower end of the magnetic stator 230, a bearing chamber 255 may be formed between the magnetic rotor 260 and the housing 250 proximate the anvil 220. This bearing chamber may be filled with a lubricant such as oil or cutting fluid, which can prolong the life of the components, as opposed to the erosive and corrosive nature of drilling mud.

Percussion drill bit assembly 200 includes passageway 243 located in magnetic rotor 260. As shown in FIGS. 2 and 3, passageway 243 is a central passageway coaxial with a longitudinal axis of the percussion drill bit assembly 200. As described herein, fluid may be provided downhole to the percussion drill bit assembly 200 during operations, e.g. drilling fluid or air, for cuttings removal, drill bit cleaning, bottom hole cleaning, drill bit cooling.

As discussed herein with respect to percussion drilling assembly 100, sensors may likewise be located in various components of the percussion drilling assembly 200. According to embodiments of the present disclosure, at least one sensor may be located in at least one of the housing 250, the magnetic stator 230, the magnetic rotor 260, the anvil 220, and the bit box assembly 270. As used herein, the term “components” may also refer to the housing 250, the magnetic stator 230, the magnetic rotor 260, the anvil 220, or the bit box assembly 270. One or more components of the percussion drilling assembly 200 may include a sensor located therein or thereon, as described herein with respect to percussion drilling assembly 100. For example, percussion drilling assembly 200 may include any type of sensor or logger known in the art, for example, temperature, pressure, acceleration, flow, optical, touch, etc. The sensors may be located in one or more cavities formed in the components. The types of measurements taken by the sensor(s) provided in the percussion drilling assembly 200 may also be the same as those described herein with respect to percussion drill bit assembly 100.

Further, a sensor may be provided in the percussion drilling assembly 200 to measure the rotation of a selected component. For example, a transmitter of a magnetic or optical sensor may be provided to the magnetic rotor 260. The transmitter of the magnetic or optical sensor may be placed in a cavity similar to cavity 770 of feed tube 160 illustrated in FIG. 7. The cap located in the cavity may include a transparent window. For example, the sensor may be positioned in cavity in a wall of the housing 150 and a transparent, e.g., plexiglass, window may be installed over the sensor and sealed in place. The corresponding receiver may be positioned on the anvil 220 or the housing 250. The window may ensure a line of sight is provided between the transmitter and receiver. According to another embodiment, a touch sensor may be located on the magnetic rotor 260 or the magnetic stator 230 and act as a tachometer, counting the times the touch sensor is depressed in order to calculate rotation. According to yet another embodiment, a centripetal force sensor may be located in a cavity on the housing 250 to measure rotational acceleration of the rotor 260.

A sensor may be provided to the percussion drilling assembly 200 to measure a property of a fluid therein. The fluid may be a drilling fluid located in the passageway 243 or fluid located in the bearing chamber 255. For example, pressure, temperature, or other sensors may be located along the magnetic rotor 260. As described with respect to the feed tube 160 of FIG. 7, multiple temperature, pressure, or other sensors may be positioned along the length of the rotor such that the empirical data collected may be used to form a gradient representative of the magnetic rotor 260, the fluid in the passageway 243, or both the magnetic rotor 260 and the fluid in the passageway 243. Sensors may also be located in the housing 250 to measure a temperature, pressure, or other property of fluid in an annulus between the drill bit assembly 200 and a wall of the borehole. The temperature or pressure sensors may be located in cavities similar to those illustrated in FIG. 7.

As noted herein, sensors provided to the percussion drilling assembly 200 may measure strain or stress of a component with, for example, a strain gauge or temperature logger (which measures the strain indirectly through thermal expansion calculations). Additionally, sensors may be provided to measure kinematics of, for example, the anvil 220. The arrangement of sensors to measure the kinematics of the anvil 220 may be similar to that described herein, for example with respect to FIGS. 8 and 9. The kinematics may also be measured with a magnetic, optical, or touch sensor located on at least one of the magnetic rotor 260, the magnetic stator 230, the anvil 220, or the housing 250, as described herein with respect to percussion drill bit assembly 100.

A percussion drill bit assembly in accordance with embodiments described herein may be manufactured by forming at least one cavity in at least one component of the percussion drilling assembly. The component may be at least one of, for example, a drill bit, a piston, a rotor, a stator, a feed tube, a feed tube housing, or an assembly housing, although any number or combination of these components may include at least one cavity for monitoring multiple areas of the drilling assembly.

Once the at least one cavity is formed in at least one of the components, a sensor or logger may be positioned therein. The sensor may be one selected from, for example, pressure sensors or loggers, temperature sensors or loggers, optical sensors, “touch sensors”, position sensors, strain gauges, accelerometers, magnetic sensors, centripetal force sensor, etc. The cavity may be sealed to secure the sensor in place, to prevent damage to the sensor (e.g., by preventing fluid from entering the cavity during use), or for other purposes. The cap may be a rubber element, an epoxy or sealant, a plate (e.g., metallic, plastic, composite, etc.) sealed with an O-ring or sealant, or any sealing member used to seal a cavity known in the art. The at least one sensor may then be coupled (by wired connection or wireless transmission) to a control center located on the drill string or located in drilling assembly 100. The control center may send the measurements and empirical data collected from the sensors uphole, communicate with components in the percussion drilling assembly or drill string, or facilitate other communication or data transfer. For example, the control center may monitor the fluid pressure in the central chamber 155 and communicate the corresponding measurements to the surface. If the fluid pressure is too large, the control center may instruct the check valve 145 to decrease the flow rate of fluid to the drilling assembly 100. In some embodiments, the control center may be located uphole. In other embodiments, no control center may be used, and the sensors may record measurements that can then be accessed uphole upon completion of drilling.

Percussion drill bit assemblies having at least one sensor located on at least one component in accordance with embodiments disclosed herein may be coupled to a lower end of a drill string to drill a geological formation. The at least one sensor may measure at least one property of the percussion drill bit assembly while drilling the formation. Furthermore, measurements may be taken before, during, and after drilling.

The sensor may be programmed to activate, i.e., begin measuring, in response to a trigger event. For example, a sensor may be programmed to activate in response to a predetermined fluid flow rate. Once the sensor detects the predetermined flow rate downhole, the sensor will activate and begin measuring. Other examples of trigger events may include a predetermined rate of rotation, a pressure pulse, a predetermined weight on bit, or a pre-determined acceleration of the percussion drilling assembly. By programming sensors to respond to different trigger events, multiple sensors positioned in the percussion drill bit assembly may be activated to measure at least one property at different times during operation. According to another embodiment, the measuring may begin after a predetermined amount of time has elapsed. For example, the sensor may be programmed to begin measuring in an hour after being programmed or activated. According to another embodiment, a signal may be sent from the surface to the sensor, for example, through the control center, to begin measuring.

Measurements taken by the sensor(s) may be retrieved and analyzed during or after the operation of the percussion drilling assembly. For example, once drilling is completed and the drill string pulled uphole, the sensors or loggers may be recovered and the empirical data (i.e., measurements) may be uploaded to a computer. In other embodiments, the sensors may be in communication with a control center, which relays the measurements uphole to the surface in real time. The analysis may include updating a model or models of the percussion drilling assembly with the measurements. Some measurements may undergo further evaluation before being transferred to a model or simulation. For example, temperature measurements taken by a sensor located in the feed tube housing 130 may also be used to indicate thermal strain of the feed tube housing 130. Thus, the resulting thermal strain caused by changes in temperature may be calculated prior to updating a model with the temperature information. In some embodiments, the further evaluation may be performed in the model. Referring to the previous example, the thermal strain may be calculated as a part of the simulation.

The updated model may provide a more accurate simulation of downhole conditions during operation of the percussion drill bit assembly. Based on the analysis, i.e., updated model, a new percussion drilling assembly may be designed for future drilling operations. The new percussion drilling assembly may be designed by modifying at least one physical parameter of a component of the drilling assembly, as described in examples provided below.

Pressure or temperature measurements (or both pressure and temperature measurements) with respect to time of the central chamber 155 or bearing chamber 255 may indicate the efficiency of the chamber. If the central chamber 155 or bearing chamber 255 is performing inefficiently, then the physical parameter modified may include, for example, the length of the piston 120 or anvil 220, diameter of the feed tube 160, or the size of the ports 125 to improve the design of the chamber. In another example, referring to FIG. 2, if the analysis determines temperature measurements collected by temperature sensors located proximate seal assembly 240 approach or exceed thermal limits, i.e., a melting point, of the materials used to form seal assembly 240, then the physical parameter modified may include the material used to form seal assembly 240 for future designs. Other examples of physical parameters that may be modified based on the analysis may include, for example, but are not limited to, diameters (inner or outer or step-down) of the piston, a material composition of a component of the percussion drilling assembly, a size of the at least one port, or a location of the at least one port, the length of a fluid passageway, the strike face area, or any other suitable parameter.

The details provided herein with respect to using analysis to modify designs of percussion drill bit assemblies are provided by way of example. One skilled in the art will recognize that numerous such modifications may be made based on the analysis without departing from the scope of the present disclosure.

Once a new percussion drilling assembly is designed, the modified parameters of the new percussion drilling assembly may be input into the model to perform an updated simulation. Based on the performance of the new percussion drilling assembly in the simulation, the new percussion drill bit assembly may be manufactured for further testing or use downhole. If the new percussion drilling assembly does not perform better than the original percussion drilling assembly design, then a different physical parameter may be adjusted from the original model, and a second new drill bit assembly may be modeled and simulated.

In addition to informing design decisions for future percussion drill bit assembly models, embodiments disclosed herein may allow the percussion drill bit to respond to the measurements downhole in real time. Sensors in communication with the control center may send measurements to the control center during operation. The control center may determine based on measurements taken by the sensors to adjust a component positioned uphole from or in the percussion drilling assembly. For example, if the fluid flow rate to the piston 120 and central chamber 155 is too large and risks damaging downhole components, the control center may send instructions to an adjustable valve to restrict the flow or to an adjustable bypass valve to redirect excess flow past the components in danger.

Although only a few embodiments have been described in detail herein, those skilled in the art will readily appreciate that many modifications are possible in the example embodiments without materially departing from the apparatus, systems, and methods disclosed herein. Any element described in relation to an embodiment herein may be combinable with any element of any other embodiment described herein. For example, while each component having sensors therein was described in detail independently, one skilled in the art would readily understand that any combination of sensors located in components may be used without departing from the scope of the present disclosure. For example, a percussion drilling assembly according to embodiments of the present disclosure may include a piston, feed tube housing, feed tube, and housing having sensors therein. The sensors may be provided to measure the same property, e.g., measure a property of the upper chamber, or the sensors may be provided to measure different properties of the percussion drill bit assembly, e.g., measure a property of the upper chamber, measure acceleration of the piston, or measure a property of the lower chamber. As another example, a percussion drilling assembly may include a single component having at least one sensor located therein, e.g., a piston having at least one sensor therein.

Further, although each component is not illustrated in the figures as having sensors located therein, examples of sensors located in various components are illustrated in the figures along with an accompanying description. In view of these figures and descriptions, one skilled in the art would readily understand how to position a sensor in a corresponding component and like components. Accordingly, all such modifications are intended to be included within the scope of this disclosure.

The drawings are to scale for some embodiments of the present disclosure and may be used for relative dimensions of various features. The drawings are illustrative, however, and are not to scale for each embodiment within the scope of the present disclosure.

In the claims, means-plus-function clauses are intended to cover the structures described herein as performing the recited function and not just structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke means-plus-function or other functional claiming for any limitations of any of the claims herein, except for those in which the claim expressly uses the words ‘means for’ together with an associated function. Each addition, deletion, and modification to the embodiments that fall within the meaning and scope of the claims is to be embraced by the claims.

What is claimed is:

1. A drilling assembly comprising:
a housing;
a percussion drill bit slidingly disposed within a lower end of the housing;
a piston slidingly disposed longitudinally above the percussion drill bit within the housing;
a feed tube housing longitudinally above the piston within the housing;
an upper chamber above the piston;
a lower chamber below the piston;
a feed tube within the feed tube housing, the feed tube being in fluid communication with at least one of the upper chamber or the lower chamber; and
at least one sensor in at least one of the housing, the piston, the feed tube housing, or the feed tube.

2. The drilling assembly of claim 1, the at least one sensor including at least one of a pressure sensor, a temperature sensor, an optical sensor, a touch sensor, a position sensor, a strain gauge, or an accelerometer.

3. The drilling assembly of claim 1, further comprising a cavity formed in at least one of the piston, the feed tube housing, the feed tube, or the housing, the cavity having the at least one sensor therein.

4. The drilling assembly of claim 3, further comprising a seal in the cavity, the seal restricting fluid contact with the sensor.

5. The drilling assembly of claim 1, the feed tube housing including at least two sensors.

6. The drilling assembly of claim 1, the upper chamber being between the piston and the feed tube housing, and the lower chamber being between the piston and the drill bit, and the at least one sensor monitoring at least one property of the upper chamber or the lower chamber.

7. The drilling assembly of claim 1, the piston including a cavity at an upper end that houses the at least one sensor.

8. A percussion drilling assembly comprising:
a housing;
a percussion drill bit slidingly disposed within a lower end of the housing;
at least one of a piston or an anvil slidingly disposed above the drill bit within the housing; and
at least one sensor in at least one of the housing, the piston, or the anvil.

9. The percussion drilling assembly of claim 8, the percussion drilling assembly being magnetically actuated.

10. The percussion drilling assembly of claim 8, the percussion drilling assembly being pneumatically or hydraulically actuated.

11. The percussion drilling assembly of claim 8, the at least one sensor including at least one of a pressure sensor, a temperature sensor, an optical sensor, a magnetic sensor, a touch sensor, a tachometer, or an accelerometer.

12. The percussion drilling assembly of claim 8, further comprising a rotor operatively coupled to the percussion drill bit, wherein the at least one sensor monitors a property of the rotor.

13. The percussion drilling assembly of claim 12, the at least one sensor monitoring a property of the piston.

14. A method comprising:
drilling a formation with a percussion drilling assembly having at least one sensor in a component of the percussion drilling assembly;
measuring at least one property of the percussion drilling assembly with the at least one sensor;
analyzing measurements from the at least one sensor; and
designing a new percussion drilling assembly based on the analysis.

15. The method of claim 14, further comprising triggering an event activating the at least one sensor, wherein the triggering includes at least one of providing a specific fluid flow rate to the percussion drilling assembly, providing a rotation to the percussion drilling assembly, providing a pressure pulse to the percussion drilling assembly, providing a specific weight on bit on the percussion drilling assembly, or providing an acceleration of the percussion drilling assembly.

16. The method of claim 14, wherein measuring the at least one property is triggered by elapse of a predetermined amount of time.

17. The method of claim 14, further comprising sending instructions to a valve above the percussion drilling assembly to adjust a fluid flow rate to the percussion drilling assembly in response to a signal from at least one of a surface location or a control center on a drill string.

18. The method of claim 14, wherein analyzing the measurements includes inputting the measurements into a model of the percussion drilling assembly and updating the model of the percussion drilling assembly with the measurements.

19. The method of claim 14, wherein designing the new percussion drilling assembly includes modifying at least one physical parameter of a component of the percussion drilling assembly.

20. The method of claim 14, further comprising building the new percussion drilling assembly produced in the designing of the new percussion drilling assembly.
